(19) United States
(12) Patent Application Publication
(10) Pub. No.: US 2025/0218225 A1
(43) Pub. Date: Jul. 3, 2025

(54) A METHOD FOR DETECTING ANOMALIES IN IDENTITY VERIFICATION

(71) Applicant: Raritex Trade Ltd, Nicosia (CY)

(72) Inventor: Nikita Evgenievich MARSHALKIN, Berlin (DE)

(73) Assignee: Raritex Trade Ltd, Nicosia (CY)

(21) Appl. No.: 18/399,976

(22) Filed: Dec. 29, 2023

(51) Int. Cl. G06V 40/40; G06V 10/74; G06V 10/77; G06V 10/82; G06V 20/40; G06V 30/416; G06V 30/418; G06V 30/42; G06V 40/16

(52) U.S. Cl. CPC G06V 40/40; G06V 10/761; G06V 10/77; G06V 10/82; G06V 30/416; G06V 30/418; G06V 30/42; G06V 40/168; G06V 40/172; G06V 20/41

(57) ABSTRACT

The technical solution aims to verify digital identity and more particularly to verify digital identity by online proofing.

A method for detecting anomalies in identity verification performed by a processor comprises the following steps (FIG. 1, FIG. 2): receiving an identity verification request comprising image data (10), wherein the image data contains a person's face; generating an image data descriptor (11) using a model (20) configured to determine a set of visual features not associated with the person's face in the input image data (10); searching for image data descriptors similar to said generated image data descriptor (11) among image data descriptors belonging to other identity verification requests; in response to finding at least one similar image data descriptor, marking said identity verification request as anomalous, otherwise marking the request as not anomalous.

### FIELD OF TECHNOLOGY

The application is directed to verifying digital identity and more particularly to verifying digital identity by online proofing.

### STATE OF THE ART

Nowadays, with the development of online services, in particular digital banking, payment and fintech services, there is a surge in fraudulent activities in this area. This includes attempts to register bank or payment accounts using fake identity in order to pass user verification and avoid know-your-client (KYC) and anti-money laundering (AML) restrictions.

Modern online-services subject to KYC regulations (e.g. digital banking, investment services, betting agencies) or services where clients' safety is at stake (taxi, carsharing, home rent) require their potential clients to pass liveness checks to verify their identity. The identity verification online normally includes submission of the client's identity document and an image or a video showing the client's face in order to prove that it is the same person who they claim to be. There are two main ways to spoof the identity verification:
Use of fake identity or identity theft via identification documents' forgery, use of physical masks, deep fakes and image or video retouching. With the proliferation of deep fake technologies, this method became much easier to perform on a high quality level and therefore more widespread;
Use of front persons, otherwise colloquially known as “money mules”, who pass user verification and for a small fee transfer control over their account to a third party.

Such fake accounts are usually used for money-laundering or financing of criminal activity, therefore it is essential to find technical solutions for detecting identity fraud.

Existing technologies of identity spoofing detection typically analyze the image of the user's facial features or the image of the identity document attempting to detect artifacts of forgery. Such technologies may not always work if the image forgery is of high quality. Existing technologies also don't detect use of front persons (also known as “money mules”) as their images and documents are not forged.

In contrast, the described solution is based on the fact that most often the fraudulent registration attempts are done in series—the liveness images or videos are made in the same room, locations, and using the same image sources (templates). This is often true in both kinds of identity spoofing—using fake or stolen identity and using front persons (“money mules”).

The claimed solution is aimed at identifying similar features in images and videos submitted for identity verification in order to detect serial verification requests that indicate identity fraud attempts.

### SUMMARY

A method for detecting anomalies in identity verification performed by a processor comprising the following steps (FIG. 1, FIG. 2): receiving an identity verification request comprising image data (10), wherein the image data contains a person's face; generating an image data descriptor (11) using a model (20) configured to determine a set of visual features not associated with the person's face in the input image data (10); searching for image data descriptors similar to said generated image data descriptor (11) among image data descriptors belonging to other identity verification requests; in response to finding at least one similar image data descriptor, marking said identity verification request as anomalous, otherwise marking the request as not anomalous.

A method for detecting anomalies in identity verification using identification documents performed by a processor comprising the following steps: receiving an identity verification request comprising image data (410) representing identification document of the person to be verified; generating a descriptor (411) of the identification document's image data (410) using a model (420) configured to determine at least one of: a set of visual features not associated with the person's identification document represented in the identification document's image data (410); a set of visual features not associated with the person's face image in the identification document represented in the image data (410); searching for identification documents' image descriptors similar to said generated descriptor (411) of the identification document's image data (410) among image descriptors belonging to other identity verification requests; in response to finding at least one similar identification document's image descriptor, marking said identity verification request as anomalous, otherwise marking the request as not anomalous.

A method for detecting anomalies in identity verification using identification documents performed by a processor comprising the following steps: receiving an identity verification request comprising an image data (410) representing identification document of the person to be verified; generating a descriptor (411) of an identification document's image data (410) using a model (420) configured to determine at least one of: a set of visual features not associated with the person's identification document represented in the identification document's image data (410); a set of visual features not associated with the person's face and/or other identification document's data pictured in the identification document represented in the image data; searching for identification documents' image descriptors similar to said generated descriptor (411) of an identification document's image data (410) among identification documents' image descriptors belonging to other identity verification requests; in response to finding at least one similar identification document's image descriptor, mark said identity verification request as anomalous, otherwise mark the request as not anomalous.

### BRIEF DESCRIPTION OF THE DRAWINGS

FIG. 1—block diagram illustrating one of possible variants of realization

FIG. 2—scheme illustratively describing descriptor formation in one of the variants of realization

FIG. 3—block diagram illustrating one of possible variants of realization of the technical solution

FIG. 4—scheme illustratively describing the formation of a descriptor in one of the variants of realization

FIG. 5—scheme of possible realization of the system implementing the described technical solution

FIG. 6—scheme illustratively describing formation of a descriptor in one of the embodiments and storing it in a database

FIG. 7—scheme illustratively describing the formation of a descriptor in one of the embodiments and saving it in the database

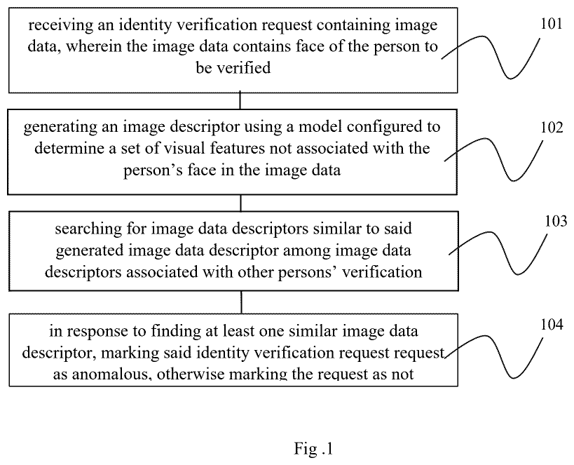

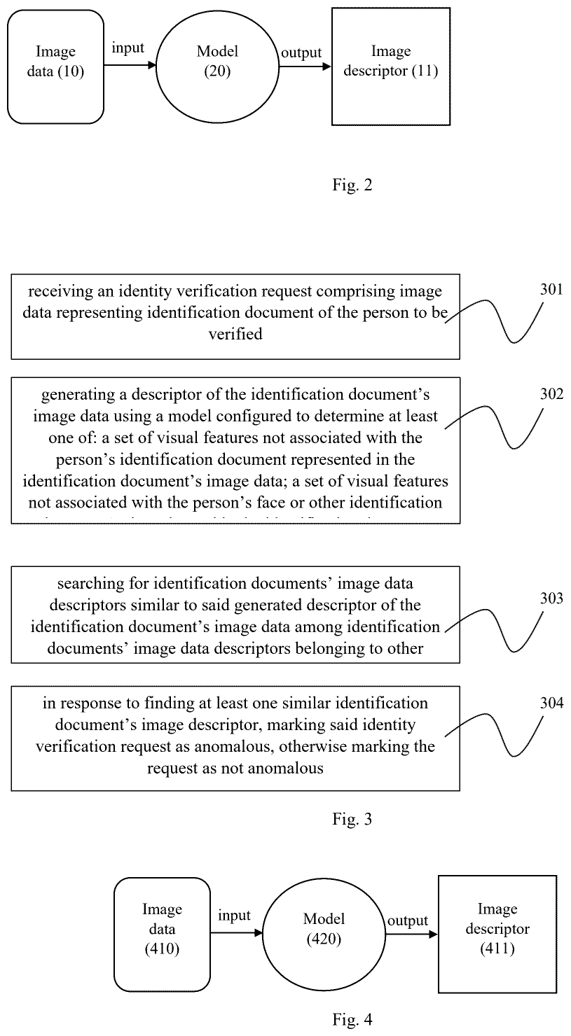

### DETAILED DESCRIPTION

Identity verification is the process of confirming that the identity an individual claims to possess matches their true identity.

In some cases, depending on the context and the verification process, the concepts of a user and a person may be equivalent, and in some cases they may not. For example, in some systems it is possible to register the same person under different logins, which means that several user accounts can be associated with the same person.

A user starts identification session (for example, necessary for registration with the service or, for example, as one of the stages of the authorization process) on a device (smartphone, tablet, laptop, personal computer) containing a photo or video camera through a special application (native, web application or any other) that captures photo and/or video data, and, if necessary, asks to fill in the personal data required for identification of the user and collects non-personal data, if necessary. This data is then transmitted to a remote server, which verifies the user and performs fraud detection.

In some embodiments, the solution may be used to detect fraudulent serial account registration applications, where one of the steps to verify a user is to take snapshots (selfies) containing the user's face. In some embodiments, the solution may be used to detect identity verification fraud.

A method for detecting anomalies in identity verification performed by a processor includes the following steps:

Step 1: receive an identity verification request including user data and image data (10) comprising the face of the user being verified.

The image data (10) includes at least one video or at least one static image or a combination of them.

In some embodiments, the verification application's image data (10) includes a video (a video stream, a video file fragment) comprising a face of the user whose identity is being verified.

In some embodiments, the verification application's image data (10) includes a static image (a photograph, a screenshot, a frame from a video) comprising a face of the user whose identity is being verified.

In accordance with at least one non-limiting embodiment, the user data includes personal and/or non-personal data of the user.

In some embodiments, the personal data may include, but is not limited to, one or a combination of the following aspects: full name, date of birth, tax identifiers, passport or ID information, social security number, phone number, e-mail.

In some embodiments, the non-personal data includes-identifiers of the device from which the user is being authenticated, such as component serial numbers, information about installed applications, application versions, information about the device manufacturer, OS and its version, IP address, etc.

In some embodiments, the user data is required to pre-check whether the request is a duplicate/repeat. In case the request has already been sent, it is checked whether the image data (10) in the current and earlier requests is identical. If they are identical, processing of the request is stopped.

In some embodiments, computer vision algorithms (methods, techniques), such as those implemented in OpenCV, and/or deep learning algorithms, such as, but not limited to, Faster-RCNN, YOLO, SSD (Single shot multibox detector), are used to determine (detect) the presence of the user's face (human face).

Step 1.1: in response to receiving image data (10) comprising video in the identity verification application, at least one static image or a video fragment containing the face of the user whose identity is being verified is extracted from the video.

In some embodiments, the image data (10) comprising video is partitioned into a sequence of video frames/images, and then the video frames/images containing the face of the user undergoing verification are extracted (selected, filtered).

In some embodiments, the image data (10) comprising video is partitioned into a sequence of video fragments, and then the video fragments containing the face of the user undergoing verification are extracted (selected, filtered).

Step 2: generate a descriptor (11) of the image data (10) by transmitting the image data (10) to a model (20) trained to determine the visual features associated with the background of the image or video and ignoring the faces of the users (ignoring visual features associated with the user's face) pictured in the image of video.

In some embodiments the descriptor (11) is a numerical representation of visual features of image data.

In some embodiments the descriptor (11) is a vector embedding that represents image data (10) as a point in a multidimensional space.

In some embodiments the descriptor is a hash value of visual features of the image data (10).

In some embodiments, the model (20) is trained with the ability to detect similarities between the video data belonging to different verification sessions on the basis of comparing visual features not associated with the faces of users.

In some embodiments, the model (20) is trained with the ability to detect similarities between the image data (10) belonging to different verification sessions on the basis of comparing visual features not associated with the faces of users.

In some embodiments, the model (20) is trained with the ability to form a descriptor (11) of image data (10) by determining the visual features associated with the face of the user (ignoring visual features associated with the user's face).

In some embodiments, the model (20) is trained with the ability to form a descriptor (11) of image data (10) by determining the visual features associated with the background and ignoring the body, clothing of the user (ignoring visual features associated with the user's body and clothing).

In some embodiments, the model (20) is trained with the ability to form a descriptor (11) of image data (10) by determining the visual features associated with the background and ignoring the face, body, clothing of the user (ignoring visual features associated with the user's face, body, and clothing).

In some embodiments, the model (20) may be a trained neural network, a machine learning algorithm, algorithms based on decision trees, ensembles and combinations of such algorithms.

In some embodiments, a convolutional neural network with an EfficientNet architecture, such as EfficientNet-B0, is used as the model (20).

In some embodiments, a convolutional neural network with a ResNet architecture is used as the model (20).

In some embodiments, a convolutional neural network with a ResNet50 or ConvNeXt-L or ResNet-101 or ResNet-152 or EfficientNet-B4 architecture is used as the model (20).

In some embodiments Visual Transformers (for example, ViT-B/16) is used as the model (20).

The typical structure of a CNN consists of three basic layers:
Convolutional layer: These layers generate a feature map by sliding a filter over the input image and recognizing patterns in images.
Pooling layers: These layers downsample the feature map to introduce Translation invariance, which reduces the overfitting of the CNN model.
Fully Connected Dense Layer: This layer contains the same number of units as the number of classes and the output activation function such as “softmax” or “sigmoid”.

In some embodiments, an average pooling layer is added to the output layer of the convolutional neural network.

Average pooling: This pooling layer works by getting the average of the pool. Average pooling retains the average values of features of the feature map. It smoothes the image while keeping the essence of the feature in an image.

In some embodiments, the model (20) has an architecture comprising: a base encoder neural network configured to process an input to generate an intermediate representation of the input and a projection head neural network configured to process the intermediate representation of the input to generate a projected representation of the input.

In some embodiments, preprocessing of an image (10) containing a face of an identified user is performed. In some embodiments, the preprocessing includes changing the resolution and/or size of the image according to model architecture requirements for the input data. For example, a resolution change to 224×224, 384×384, or 640×320, but not limited to, may be performed. In some embodiments, rectangular images are reduced to square images by changing the scale and aspect ratio.

Step 3: search for descriptors similar to the descriptor generated in the previous step among descriptors related to other identity verification requests.

In some embodiments, the distance in n-dimensional space between two or more descriptors may be used as a similarity measure.

In some embodiments, measures used to evaluate the similarity of the descriptors are Euclidean Distance, Minkowski Distance, Cosine Similarity, Dot Product.

In some embodiments, the search is performed in a database of an identity verification applications storing data of previously verified users and their descriptors.

In some embodiments, the database may be relational or key-value.

In some embodiments, MySQL, PostgreSQL, and any other relational DBMS may be used as the DBMS for the database.

Step 3.1: in response to finding at least one similar descriptor, marking the identity verification request as anomalous.

In some embodiments, the anomaly indication may be a record in a database (or other data structure) or a returned result used by other methods and systems.

Step 3.2: in response to the fact that no similar descriptors are found, mark the application for verification as not anomalous.

Step 4 (optional): store in a database (or other data structure, such as memory) the user data, the image, the generated descriptor (11), the anomaly sign (state of the anomaly sign).

In some embodiments, the model (20) is trained as follows:

Step A: select many different identity verification sessions. Most of the identity verification sessions should belong to different users. In case the identity verification session contains video data, at least two different images (10) corresponding to different video frames (10).

Step B: generate a training dataset (30) containing records, wherein each record relates to a single identity verification session and includes one or more images (10) (image groups, image collections) containing facial images of the user whose identity is being verified.

For example, the dataset looks like {folder 1: image1, image2, image3; folder 2: image1, image2; folder 3: image1, image2, image3, image4}.

In some embodiments there might be an odd number of images in one record.

In some embodiments, if the identity verification application contains video, random sampling of frames to be further used is performed. In some embodiments, these may be neighboring frames, but on average they are evenly spaced frames across the video. We are interested in as diverse frames as possible.

Step C: For a subset of the dataset records, one or more images (10) and/or image fragments comprising such records are transformed.

In some embodiments, transform an image fragment comprising a user's face such that the model does not utilize features associated with the user's face during training.

In some embodiments, transform an image fragment comprising a user's body such that the model does not use features associated with the user's body during training.

In some embodiments, transforming an image portion containing clothing of the user such that the model does not use features associated with the user's clothing when training the model.

In some embodiments, one of the following effects or combinations thereof may be used to transform images or portions thereof:
Geometric transformations;
Color transformations.

In some embodiments, one or a combination of the following effects may be used to transform an image or portions thereof, but not limited to: Cutout, gaussian noise, gaussian blur, sobel filtering, color filling, inpainting, etc.

Step D: train the model (20) using the Contrastive Learning algorithm on the dataset.

Contrastive Learning is a deep learning technique for unsupervised representation learning. The goal is to learn a representation of data such that similar instances are close together in the representation space, while dissimilar instances are far apart.

Contrastive Learning is a Machine Learning paradigm where unlabeled data points are juxtaposed against each other to teach a model which points are similar, and which are different.

That is, as the name suggests, samples are contrasted against each other, and those belonging to the same distribution are pushed towards each other in the embedding space. In contrast, those belonging to different distributions are pulled against each other.

The basic contrastive learning framework consists of selecting a data sample, called “anchor,” a data point belonging to the same distribution as the anchor, called the “positive” sample, and another data point belonging to a different distribution called the “negative” sample.

The model aims to minimize the distance between the anchor and positive samples, i.e., the samples belonging to the same distribution, in the latent space, and at the same time maximize the distance between the anchor and the negative samples.

In some embodiments, images belonging to one record (one identity verification session) are considered as positive pairs and images from different records (different identity verification sessions) are considered as negative pairs.

The model (20) is trained so that the output descriptors have a high degree of similarity across frames from the same record and a low degree of similarity across frames from different records.

In some embodiments, the described model training technique can, with slight modifications in data composition, be used to detect anomalies in document verification. In this case, the difference in the technique would only be in the raw data used for training.

In some cases, the previously described technique may be used to detect anomalies in the verification process of documents, such as a passport, ID, driver license, or any other user's identification document.

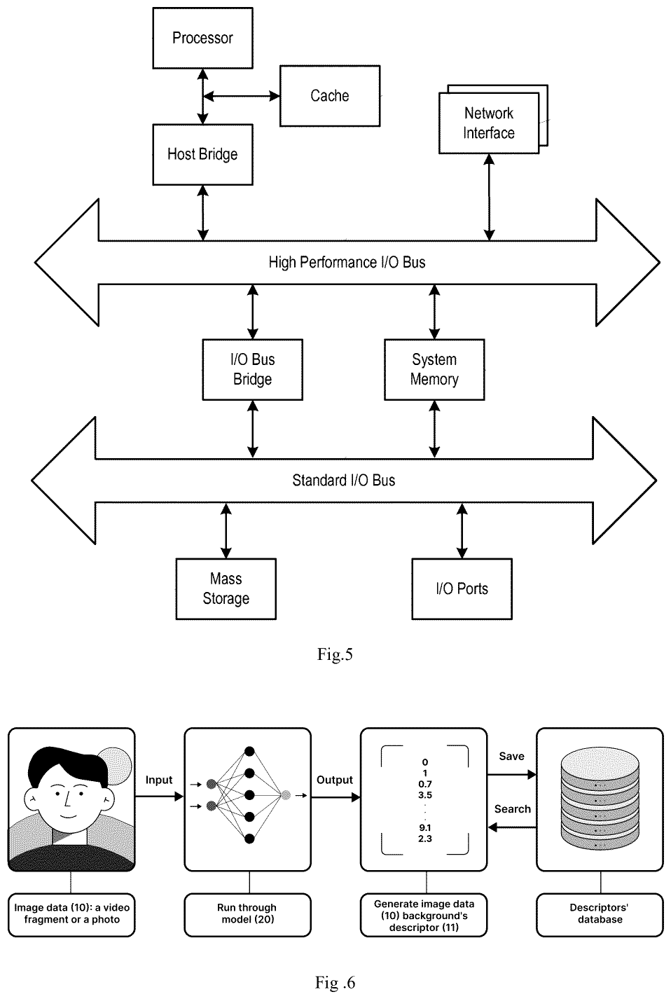

One of the embodiments of the method for detecting anomalies in identity verification performed by a processor is shown on FIG. 6.

A method for detecting anomalies in identity verification using identification documents performed by a processor comprising the following steps:

Step 1: receiving an identity verification request comprising image data (410) representing identification document of the person to be verified;

In some embodiments, the image data (410) includes a static image (a photograph, a screenshot, a frame from a video) comprising the identification document of the user.

In some embodiments, the image data (410) includes a video (a video stream, a video file fragment) comprising the identification document of the user.

In some embodiments, the identification document of the user is a verifiable document used to confirm a person's identity, containing the person's photo, personal and other data (name, date of birth, address, biometric data, document number, issuing body, issuance date, validity date).

Step 1.1: in response to receiving identification document's image data (410) comprising video in the identity verification application, at least one static image or a video fragment comprising the identification document of the user whose identity is being verified is extracted from the video.

In some embodiments, the identification document's image data (410) comprising video is partitioned into a sequence of video frames/images, and then the video frames/images containing the identification document of the user undergoing verification are extracted (selected, filtered).

In some embodiments, the identification document's image data (410) comprising video is partitioned into a sequence of video fragments, and then the video fragments containing the identification document of the user undergoing verification are extracted (selected, filtered).

Step 2: generating a descriptor (411) of the identification document's image data (410) using a model (420) configured to determine at least one of:
a set of visual features not associated with the person's identification document represented in the identification document's image data (410). In such a case, the model (420) is trained to detect visual features associated with the background, on which the document is located or pictured, or other features detected by the model (420) and ignoring the visual features associated with the identification document.
a set of visual features not associated with the person's face or the identification document's data (for example, document number, first name, last name, date of birth, address, biometric data, issuing body, validity date etc) pictured on the identification document represented in the image data (410). In such a case, the model (420) is trained to detect visual features associated with the background on which the document is located and the document range, except the photograph of the document's owner.

In some embodiments, the data in the document is identified using optical character recognition (OCR) technologies. For example, the application data is used to determine which documents a person (user) sent and/or to classify (e.g., using machine learning, neural networks, or other algorithms) and detect the data.

In some embodiments, model (420) may include two separate models (421) and (422), the choice of which model to use depends on a preliminary analysis of image data (410). The preliminary analysis may include, but is not limited to, detecting the presence of background objects, determining the boundaries of the document image. Thus, in the case where the image data contains only an image of the document and nothing else, the choice is made to analyze a set of visual features not associated with the person's face located on the identification document represented in the image data.

In some embodiments, image data (410) is input to two separate models (421 and 422) and two descriptors, 411.1 and 411.2 or one composite descriptor, are generated.

In some embodiments, such descriptors may be stored in different databases.

Step 3: searching for identification documents' image descriptors similar to said generated descriptor (411) of an identification document's image (410) among image descriptors belonging to other identity verification requests.

In some embodiments, in the case of two descriptors 411.1 and 411.2, two search operations are performed.

In some embodiments, Euclidean Distance, Minkowski Distance, Cosine Similarity, and Dot Product measures are used to evaluate the similarity of the descriptors.

In some embodiments, the search is performed in a database of an identity verification applications storing data of previously verified users and their descriptors.

In some embodiments, the database may be relational or key-value.

In some embodiments, MySQL, PostgreSQL, and any other relational DBMS may be used as the DBMS for the database.

In some embodiments, the distance in n-dimensional space between two or more descriptors may be used as a similarity measure.

Step 4: in response to finding at least one similar identification document's image descriptor, mark said identity verification request as anomalous, otherwise mark the request as not anomalous.

In some embodiments, if at least one of the descriptors (411.1 or 411.2) matches, the application is flagged as anomalous.

In some embodiments, the anomaly indication may be a record in a database (or other data structure) or a returned result used by other methods and systems.

Step 4.1: in response to the fact that no similar descriptors are found, mark the application for verification as not anomalous.

Step 5 (optional): store in a database (or other data structure, such as memory) the user data, the image, the generated descriptor (411/411.1/411.2), the anomaly sign (state of the anomaly sign).

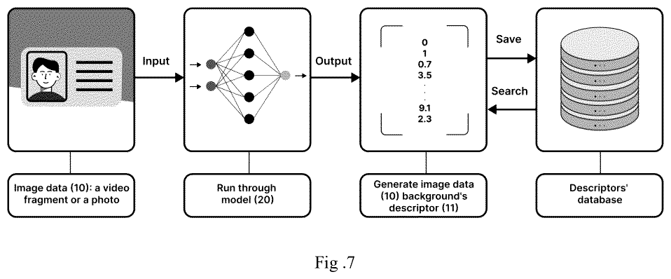

One of the embodiments of the method for detecting anomalies in identity verification using identification documents performed by a processor is shown on FIG. 7.

The foregoing processes and features can be implemented by a wide variety of machine and computer system architectures and in a wide variety of network and computing environments. FIG. 5 illustrates an example of a computer system that may be used to implement one or more of the computing devices identified above. The computer system includes sets of instructions for causing the computer system to perform the processes and features discussed herein. The computer system may be connected (e.g., networked) to other machines. In a networked deployment, the computer system may operate in the capacity of a server machine or a client machine in a client-server network environment, or as a peer machine in a peer-to-peer (or distributed) network environment. In an embodiment of the invention, the computer system may be one server among many that constitutes all or part of the verification/authentication system.

The computer system includes a processor, a cache memory, and one or more executable modules and drivers, stored on a computer readable medium, directed to the processes and features described herein. Additionally, the computer system includes a high performance input/output (I/O) bus and a standard I/O bus. A host bridge couples processor to high performance I/O bus, whereas I/O bus bridge couples the two buses and to each other. A system memory and one or more network/communication interfaces couple to bus. The computer system may further include video memory and a display device coupled to the video memory (not shown). Mass storage, and I/O ports couple to the bus. The computer system may optionally include a keyboard and pointing device, a display device, or other input/output devices (not shown) coupled to the bus. Collectively, these elements are intended to represent a broad category of computer hardware systems

For purposes of explanation, numerous specific details are set forth in order to provide a thorough understanding of the description. It will be apparent, however, to one skilled in the art that embodiments of the disclosure can be practiced without these specific details. In some instances, modules, structures, processes, features, and devices are shown in block diagram form in order to avoid obscuring the description. In other instances, functional block diagrams and flow diagrams are shown to represent data and logic flows. The components of block diagrams and flow diagrams (e.g., modules, blocks, structures, devices, features, etc.) may be variously combined, separated, removed, reordered, and replaced in a manner other than as expressly described and depicted herein.

Reference in this specification to “one embodiment”, “an embodiment”, “other embodiments”, or the like means that a particular feature, design, structure, or characteristic described in connection with the embodiment is included in at least one embodiment of the disclosure. The appearances of, for example, the phrase “in one embodiment” or “in an embodiment” in various places in the specification are not necessarily all referring to the same embodiment, nor are separate or alternative embodiments mutually exclusive of other embodiments. Moreover, whether or not there is express reference to an “embodiment” or the like, various features are described which may be variously combined and included in some embodiments but also variously omitted in other embodiments. Similarly, various features are described that may be preferences or requirements for some embodiments but not other embodiments.

The language used herein has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

1. A method for detecting anomalies in identity verification performed by a processor comprising the following steps:
receiving an identity verification request containing image data, wherein the image data contains face of the person to be verified;
generating an image data descriptor using a model configured to determine a set of visual features not associated with the person's face in the image data;
searching for image data descriptors similar to said generated image data descriptor among image data descriptors associated with other persons' verification requests;
in response to finding at least one similar image data descriptor, marking said person's verification request as anomalous, otherwise marking the request as not anomalous.

2. The method according to claim 1, wherein the model is a machine learning model with an EfficientNet or ResNet architecture.

3. The method according to claim 1, wherein the model is trained using Contrastive Learning technique.

4. The method according to claim 1, wherein the similarity of the descriptors is determined using one of the following metrics: Euclidean Distance, Minkowski Distance, Cosine Similarity, Dot Product

5. A method for detecting anomalies in identity verification using identification documents performed by a processor comprising the following steps:
Receiving an identity verification request comprising image data representing identification document of the person to be verified;
Generating a descriptor of the identification document's image data using a model configured to determine at least one of:
a set of visual features not associated with the person's identification document represented in the identification document's image data;
a set of visual features not associated with the person's face or other identification document's data pictured on the identification document represented in the image data;
Searching for identification documents' image descriptors similar to said generated descriptor of the identification document's image data among identification documents' image data descriptors belonging to other identity verification requests;
In response to finding at least one similar identification document's image descriptor, marking said identity verification request as anomalous, otherwise marking the request as not anomalous.

6. The method according to claim 5, wherein the model is a machine learning model with an EfficientNet or ResNet architecture.

7. The method according to claim 5, wherein the model is trained using Contrastive Learning technique.

8. The method according to claim 5, wherein the similarity of the descriptors is determined using one of the following metrics: Euclidean Distance, Minkowski Distance, Cosine Similarity, Dot Product.
